(19) United States
(12) Patent Application Publication
(10) Pub. No.: US 2006/0080212 A1
(43) Pub. Date: Apr. 13, 2006

(54) Real-time adaptive moduluar risk management trading system for professional equity traders

(76) Inventors: Timothy Anderson, Menlo Park, CA (US); Mark Mooney, Petaluma, CA (US)

Correspondence Address: RUBINSTEIN LAW GROUP, PROFESSIONAL CORP;PATENTS, 100 Pine Street, 20th Floor, SAN FRANCISCO, CA, 94111, US

(21) Appl. No.: 10/995,059

(22) Filed: Nov. 22, 2004

Related U.S. Application Data
(63) Continuation-in-part of application No. 10/711,128, filed on Aug. 26, 2004.

(51) Int. Cl. G06Q 40/00

(52) U.S. Cl. 705/37

(57) ABSTRACT

The present invention provides traders with a real-time fed computer-based system for trading commodities based on a traders risk profile, particularly equities, by providing a careful selection of the data to analyze and selecting the correct manipulation of that data. The invention uses the initially selected data components or factors, by manipulating them with operators, or asset specific mathematical functions, a fuzzy or Baeysian advisors helps to assist in the genetic learning of the system by being rewards and punished based on the correlation to success and failure, and overlay advisors, or meta-advisors as they are implemented in the present invention. The invention provides several control or monitoring layers which can exit and recommend immediate action or adjust the neural-based computational processes, such as iteration, based on criteria in the interpreted “multiplexed” real-time data or a discovered neural relationship.

### REFERENCE TO PRIORITY DOCUMENTS

This application is a continuation-in-part of and claims priority under 35 USC §120 to U.S. patent application Ser. No. 10/711,128, filed Aug. 26, 2004 and entitled COMPUTER-IMPLEMENTED ADAPTIVE MODULUAR RISK MANAGEMENT TRADING SYSTEM FOR PROFESSIONAL EQUITY TRADERS

### BACKGROUND

This application incorporates all the features of an experimental stock trading program called STOCKO, developed by Dr. Robert Levinson of Santa Cruz, Calif., pursuant to the extent of the applicable law under 35 USC 1 et. seq. Information regarding the STOCKO platform has also been made available to the public through several Internet sites since 1997, including www.clearstation.com, www.i.exchanqe.com, www.stockscience.com and www.drstocko.com, all of which are fully incorporated by reference, for all purposes and discussed in the background.

The prior art Artificial Intelligence-based experimental STOCKO (neural-relational analysis engine) takes advantage of some assumptions that vary from embodiment to embodiment. For example, the market is not obligated to behave as it has in the past: some consequences of this on that even the best systems will probably stop working at some point and will probably only be profitable in certain environments. With added complexity in adaptive system should be able to remain profitable. FIG. 1A shows a functional diagram of the elements of the neural-relational analysis engine.

FIG. 1B shows a functional data flow of the prior art neural analysis engine. FIG. 1C shows a sample data flow of the analysis engine in an alternate form. In step [1.00], time-series data for stocks the system covers is loaded into a historical time-series database which will also collect new time series data. In step [1.05] the time-series data is processed, the system indicators to produce an output. In step [1.10] the output of the indicator processed data and any raw factor time-series data is then loaded into Database One (DBI) where indicator output histories and weightings are stored. Each stock has its own unique record. In step [1.15] each new updated record from DBI is sent to the high-level Advisors for review. In step [1.20] all new Advisor data (predictions) is sent to the UPD where it is recorded and in step [1.25] combined by the UPD specific Neural Net Combiner after consideration of prior records which have been scored with Advisors weighted based on correlation to current market activity, to step [1.30] form a consensus, or new prediction which is then in step [1.35] recorded for reference upon receipt of the next incoming data set. In step [1.40] the scoring/weighting records are sent to the Advisors for review and possible influence on the next prediction task.

The neural analysis engine selects particular data to analyze and selecting the correct manipulation of that data. Initially, it is useful to consider the concepts of the data components of factors, indicators, advisors, and overlay advisors. The data is moved from the proprietary software backend to base-level prediction system connected series of (base level) advisers B-AD. Although only six advisers are shown in the diagram different types and configurations of advisers at the baselevel can be included for use in the analysis engine.

Nearest Neighbor advisor: Finds the historical precedent which best matches the current situation and ______ reason by analogy with that situation to make the prediction.

Decision tree advisor: The analysis engine develops a decision tree which explains 90 percent of past price movement as a function of the indicators below. Thus, the decision tree represents “patterns that predict the past.” Given a security, the Decision Tree advisor uses the current decision tree to make its forecast for that security.

Bob advisor: A method of combining the indicators based on human (Applicant's own) intuition.

Joe Advisor: A daytrading system given by Joe Di Napoli in the book “Trading with Dinapoli levels.”

FIBO advisor: A system that combines a neural net with traditional Fibonacci retracement analysis.

The Equity trading adviser equity daytrading is a study that uses all current coated indicate years with a proprietary scoring system.

Mutual fund trading adviser to proprietary mutual fund daytrading system

The applicant invention in place intelligent two-tier based agents also referred to as advisors to capture and model dynamic changes in information at run time. Technical Analysis: This rule assumes that stock prices are not random walks and that past trading behavior will provide enough information for future price behavior.

The invention may include a super adviser which is an integral part of the system architecture meta-adviser or high-level adviser or has a contrary adviser which always bets against it. Forget is not at a given time these adviser is a five to be more or less relevant to future prediction is.

Overlay advisors include the surprise overlay adviser which annihilate the difference between actual close in predicted close. Momentum overlay adviser which reading this the total change in the last ATL day's, and analysis prediction in overlay adviser which reading the signals from mid-level pattern analysis advisors to approximate the population is a trader is correlated with fouling and or fading them. Buying Pressure Overlay Advisor proprietary Spectrum indicator that adjust for trading versus chomping movements. PIVOT point overlay adviser proprietary daytrading system related to distance from three Day pivot points.

The base advisors B-AD are generally a collection of machine learning systems and can be implemented for other applications outside of financial market theories. The adviser is process specified factors indicators and trading systems that are reflective of specialized criteria of the present application. All of the advisors are reviewed with the base advisors who also review the output of the indicators processed raw data the opinions of each of the adviser is our reviewed in combine the super adviser using machine learning for what is termed in the present invention as a consensus. Resulting predictions are compared against actual price activity and advisors are rewarded are punished according to the accuracy of the contribution to the consensus.

Another example is the nearest neighbor adviser which fineness the historical precedent which best matches the current situation and reason my analogy with that situation in to make the decision The decision tree adviser: the present invention uses the decision tree which explains 90% of past price movement as a function of the operators. Across the decision tree represents patterns that predict the past. In the security the decision tree adviser uses the current decision tree to make its forecast for that security.

High-level advisors: The addition of each advisor contributed successfully to the system, so we would like to have more in the future. Of course, each advisor has an “anti” version which always bets contrary to it. For a given stock at a given time these advisors are deemed more or less relevant to future predictions. In this paper, we leave out the details of our rhythmic timing and advisor weighting mechanisms, though getting these algorithms right has been critical our success.

Factors are selected for inclusion in a particular application ad may include financial instruments that the inventor and/or machine learning have chosen to determine to have a relationship to the desired output recommendations or predictions. The relationships may be adjusted over time as positive or negative correlations to the desired output. Those factors and indicators used in the analysis engine are included in Appendix C.

The neural based analysis engine generally follows the following principles in operation:

Stock prices are not a “random-walk” and past price-volume trading behavior provides enough information (if processed carefully) for future price behavior to be predicted at a level of statistical and profitable significance.

The market is not obligated to behave as it has in the past: Some consequences of this are that even the best systems will probably stop working at some point and will probably only be profitable in certain environments. With added complexity an adaptive system should be able to remain profitable.

An extreme result of the above assumption is that the market may at times exhibit “anti-pattern” or “pattern-cancellation” behavior so that it appears to purposely break and/or punish past useful patterns beyond what a purely random market might do.

Given proper normalization and canonization of past data, all securities in all time frames exhibit behavior that is useful in helping to predict a future price move at a given time.

Despite these similarities, after normalization, each security or index may also exhibit characteristics and rhythms that are essentially their own “signature.”

A market forecasting system must be complex enough to model a large gamut of technical trading strategies at varying time frames in order to simulate the habits of populations of traders that follow (or appear to) follow these strategies.

Given a security, certain forecasting strategies will have proved to be more useful than others at predicting recent stock behavior.

A stock forecasting strategy can never be “very bad” since its very badness can be exploited by trading contrary to it. The only useless features and forecasts are those that are essentially random.

However, perversely, some “mal-features” may manage to change their success as soon as we try to exploit them, it is these mal-features that must be ignored or avoided or exploited when properly recognized.

Combining these assumptions, a useful stocks forecast can be developed as a function of a. the past price behavior of the stock, b. its past price behaviors, and the relationship to other securities in similar scenarios, c. The relative successes of various features (trading strategies) at predicting correctly or incorrectly recent price behavior (weighing these successes or failures by the amount of win or loss). These features may come from traditional technical analysis books, general and chaos theory time-series analysis, and other human or computer designed features and “expertise modules”. As long as mal-features and over-fitting can be avoided, adding new features to the system should improve performance in the long run once the system becomes adept at using these features. Additionally, d. The rhythm of the successes and failures of individual features. Features themselves may be viewed as securities for which forecasts (at a meta-level) become relevant.

The Metropolis simulated annealing strategy of “heating up” (to encourage innovation) a system that is doing poorly and “cooling” a system that doing well is a good idea. This added randomness should keep systems out of ruts created by any mal-feature behavior.

Such forecasts can be further combined and developed into risk-minimized portfolios by analyzing correlations between items, features and justifications for trades in the portfolio and creating various hedges): such as long AMZN and short YHOO (two similar Internet stocks).

Given proper normalization in a canonization of past data, all securities in all-time frames exhibit behavior that is useful in helping to be date a future price movement had given time.

The analysis engine models its technical training strategies at varying time frames in order to simulate the habits of populations of traders that follow, or appear to follow the strategies.

The experimental neural analysis relies on the principle that a stock forecasting strategy can never be very bad since it's very badness can be exploded by trading and contrary to it. The only useless feature is the forecasts are those that are essentially random. Some features may manage to change their “success” as soon as they're used.

Combine those assumptions. Forecast in the developed as a function of: A. the past price behavior of the stock, B it's past price behaviors, and relationship to other securities in similar scenarios C. The relative success of various features at predicting correctly are incorrectly recent price behavior. These features may come from traditional technical analysis.

In summary, the analysis engine uses particular combinations of machine learning components, namely, Decision Tree, Nearest Neighbor, Neural Network Combiners as well as other algorithms. Use of client-specified strategy elements, including, but not limited to, factor instruments, proprietary and non-proprietary indicators, proprietary and non-proprietary short, medium and/or long-term trading systems, fundamental data including, but not limited to, unemployment numbers, etc. Raw time-series data is processed with proprietary and non-proprietary indicators and trading systems in addition to the raw time-series data itself. Machine learning processes produce predictions of the direction of the next specified period's price movement, as well as the magnitude of the movement in dollar and percentage of instruments price terms, and, a confidence level for the predicted movement. Data produced by machine learning processes to dynamically recommend both recommended stop-loss and recommended take-profit levels reflective of current price activity. Spectrum Indicators and Spectrum Systems (Spectrum Advisors) process time-series data through an entire specified range of time horizon variations on any proprietary or non-proprietary indicator or trading system (e.g., a 5-50 day moving average) in order to use the current optimum for each prediction task. Graphical and tabular representations of the decision path lead to the trade recommendation (e.g., dynamically changing order of factors, indicators and trading systems for each new prediction task)

### SUMMARY OF THE INVENTION

The present invention provides the Cybertrader or other trading platform with similar characteristics, user the ability to offer their active trader clients a trading system which scientifically reduces their risk by using the above-discussed prior art neural analysis engine, while simultaneously increase their trading volume. The present invention provides an advantage for users in the electronic brokerage industry, as the so-called prize among competitors in the industry is over the tiny percentage of active traders who trade huge volumes of stocks on a daily basis and who generate significantly in excess of 50% of any given firm's trading volume. Increasing trading volume therefore is one of the additional objectives of the present invention.

The above-discussed neural analysis engine can be effectively applied to work in conjunction with real-time commodity trading systems with particular characteristics and/or configurations. In general, the properties of the trading program CYBERTRADER Pro® are appropriate for integrated use with the neural analysis engine as well as other CYBERTRADER® applications. This patent application fully incorporates technical, intellectual property, and marketing materials related to CYBERTRADER®, currently licensed to Schwab and its subsidiaries. These features are summarized in APPENDIX A-1, and which is incorporated by reference.

One illustration in which the present invention includes the feature which allows a trader to see a stock with a predicted dollar price change of 75 cents, see the percentage change that that dollar price change would equate to, and also see a confidence level of, for instance, of 8, on a (normalized for a preferred embodiment) scale 1-10. This feature is particularly useful to day traders, because they could make sufficient profit by trading only those stocks with the highest confidence level.

The brokerage industry requires that the frequency of the forecasts needed to be generated at appropriate intervals for various end-use for traders. A single forecast for each day might possibly not generate enough added trading volume to make the product embodying the pre attractive to the brokers.

An inventive business model for using the present invention is to license the product to major re-distributors such as Charles Schwab, and other large electronic brokerage firms, E-Signal, and other large vendors of raw price data for them to, in turn, provide the inventive product to their client base and pay accordingly. It was commonly thought the product would best be licensed by simply creating a website and charging users on a “per hit” basis. The real monetary reward was to come from the re-distributors as they saw the as first as a competitive advantage and later as a “must have” item to match the competition.

The output ranks the stocks by confidence level, both on the buy side and on the sell side. In addition to the price movement forecasts. The present invention improves on the experimental artificial intelligence platform through the “publishing” of the scientifically generated stop loss and take profit levels. This was a huge improvement over the rather casual and unscientific techniques employed by most day traders up unto that time. From the brokerage firm's perspective, this was a great enhancement in that it increased the odds of their clients remaining solvent, thereby increasing the life and activity of the account. Our stop loss and take profit levels were also adjustable to accommodate the particular client's risk preference. There is provided more detail on this feature and its value in the original document. These enhancements to the outputs were a major advance for marketing the present invention. The ultimate goal being possibly a real time forecast feed. The ability to increase the frequency of predictions is directly related to the inclusion of the “decision factors” of choosing. Prior to the inclusion of these “real time” factors, the (prior art version) of the system was more reactive than pro-active. The goal immediately became to make the brokerage firms' clients more profitable (or less unprofitable) and to stimulate trading activity. That was the reason so many changes and additions were required to both the inputs, outputs and timing thereof. Instead of simply producing Buy, Sell, Hold recommendations, the invention uses actual dollar prices. The invention then moved to forecasting a specific price movement for each stock, complete with direction of movement, magnitude of movement (both in % and in dollars), and confidence of movement.

### BRIEF DESCRIPTION OF THE DRAWINGS

FIG. 1A illustrates the basic interactive components of the predictive advisors in the prior art artificial intelligence equity analysis program;

FIG. 1B illustrates sample data flow in the prior art equity analysis system;

FIG. 1C shows another view of data flow in the prior art;

FIG. 2 illustrates the general architecture in which the analysis engine is implemented on virtual computer (off-site) in the present invention with a trading system such as or other trading system with such characteristics;

FIG. 3A illustrates a sample data flow and architecture of the present invention implementing the analysis engine with a real-time data feed and an appropriate trading system;

FIG. 3B is another configuration of the data flow in the invention with the real-time feed updating the factors and indicators or data array;

FIG. 4 shows the multiple levels of the real-time data feed to the analysis engine in an alternate embodiment;

FIG. 5 shows the data flow of the analysis engine with a monitoring system controlled partially by the real-time data feed.

FIG. 6A is sample output of the present invention;

FIG. 6B illustrate some sample output in detail;

FIG. 7 illustrates the real-time control of the trade recommendation output/override;

FIG. 8 illustrates the conceptual monitor layer as it may be implemented inside or outside the neural analysis engine;

FIG. 9 illustrates a sample of real-time data feed as implemented into the data flow of the neural engine;

FIG. 10 shows an iteration adjustment mechanism;

FIG. 11A shows a first contingency trading bypass data flow;

FIG. 11B shows a second contingency (neural relational discovery) trading bypass data flow;

FIG. 11C shows a third bypass data flow (zero confidence/undefined parameter);

FIG. 11D shows a fourth trading bypass data flow (Baeysian empty set);

FIG. 12 is a factor or operator adjustment system; and

FIG. 13 shows iterative adjustment control from a trading computer.

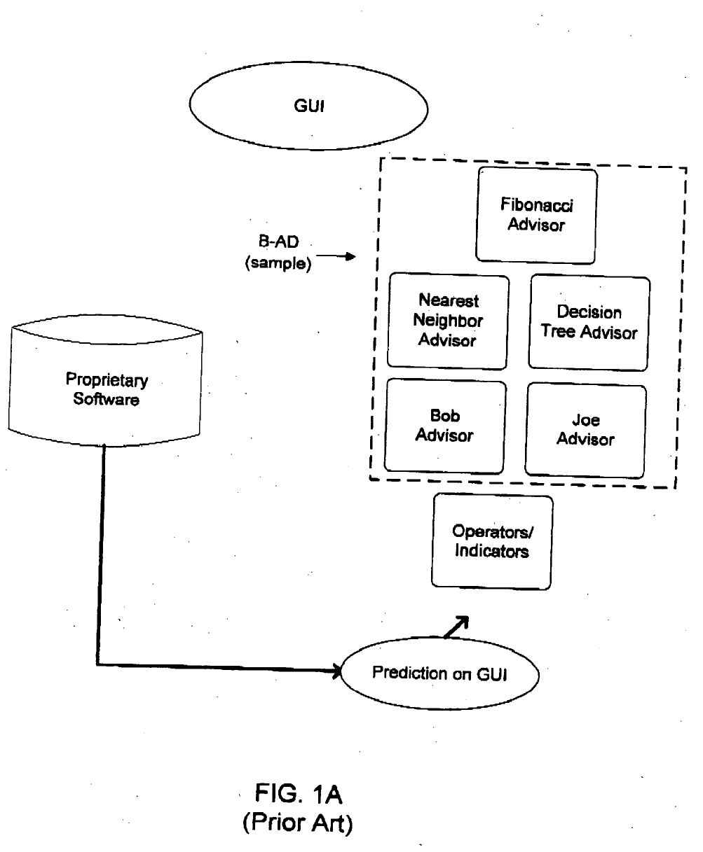

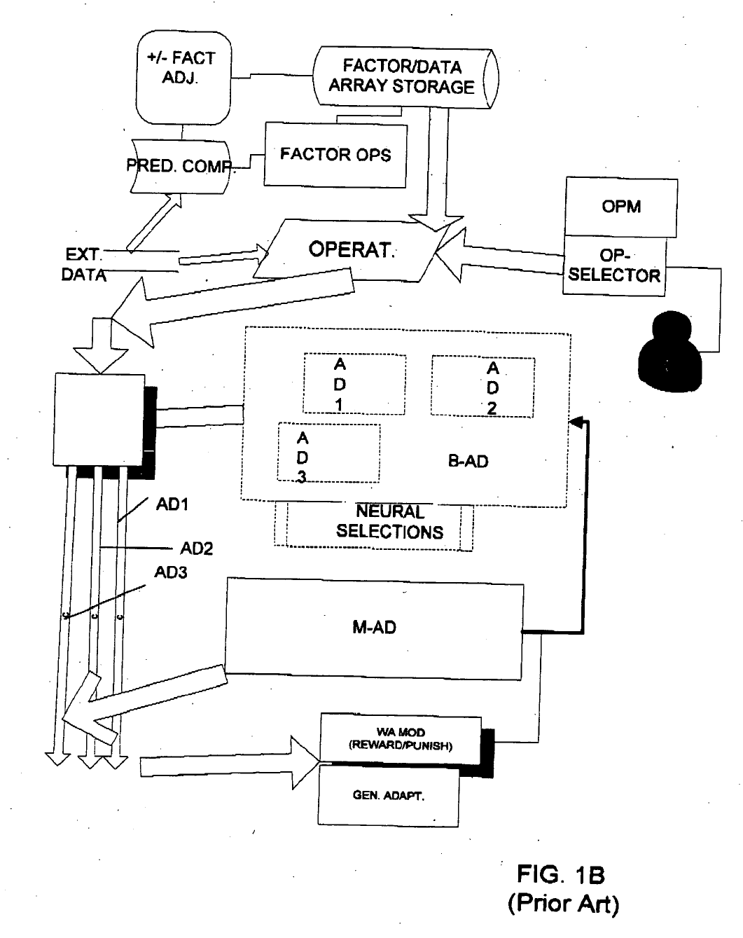

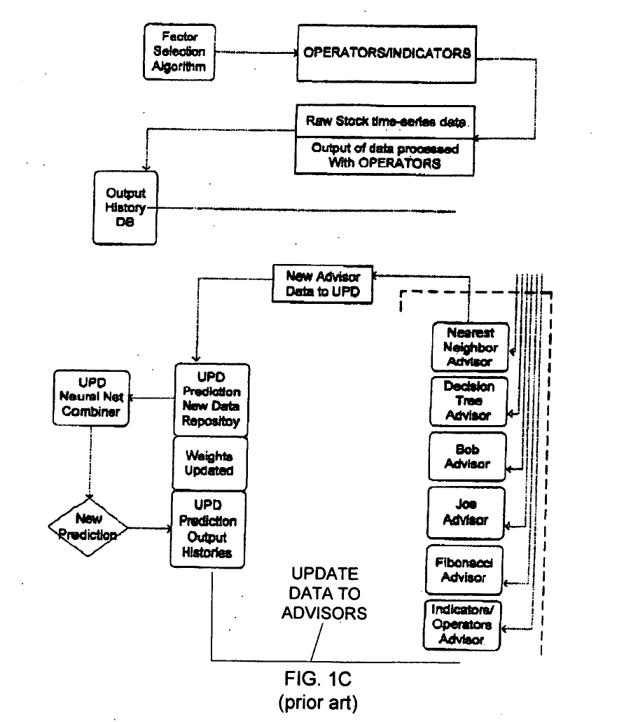

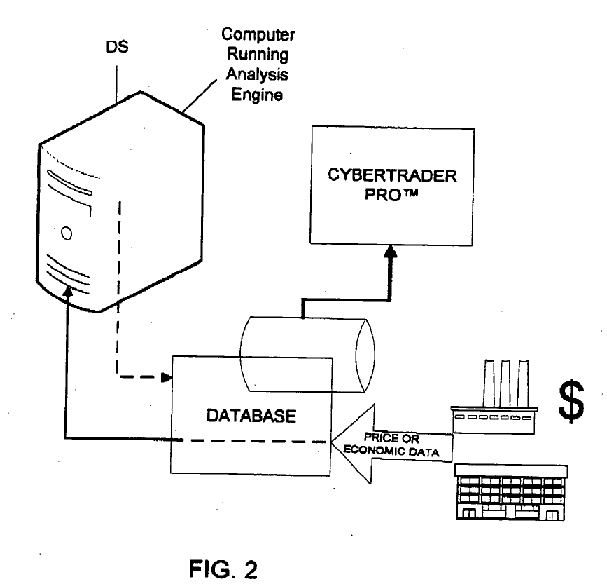

### DETAILED DESCRIPTION

The present invention provides the architecture and data flow, such that the above-described neural analysis engine may be commercially implemented for active commodity trading, and equity trading in particular. Due to the fact that active traders require as much “executable” information at their fingertips as possible, a preferred embodiment of the invention operates in its own window on the CyberTrader™ Windows-based platform or other platform that is capable of accepting a data feed and performing certain transactions. The “own window” embodiment allows a trader to have immediate access to the most current forecasts for their stocks of interest, allowing the trader to execute immediately from the same screen.

The present invention also may include several sophisticated techniques and features which addressed the active trader market specifically and increased the likelihood of their extended viability by increasing their profitability and reducing their risk. A preferred embodiment of the present invention includes a risk profile adjustment feature which would allow the user to determine their own risk profile. In a preferred embodiment, there would three categories of risk: Low, Medium and High, but other types of organization could also be used. Each level would have an automatically triggered stop-loss or take-profit associated with it. For example, a High risk profile client would set their take-profit trigger at 100% of our predicted magnitude and set their stop-loss trigger at, for instance a decline of 50% of our predicted movement. A Medium risk profile would take profit at 75% of our forecast move and their stop-loss at a decline of 30% of our forecast. A Low-risk profile would, in a typical scenario, set an end-user's take profit level at 50% of our forecast and the stop-loss at a 15% decline point.

In addition to the pre-set profiles, each brokerage firm implementing various embodiments of the invention could choose to let their traders or clients set their specific levels, outside of the “canned” versions. All of these levels could be accompanied by “rolling” stop-losses and take profits which would move up or down in accordance with the price movement of the particular stock. In other words, the user could determine to take no profit at the level forecasted by the neural analysis engine, expecting the stock to move even further (up or down). Simultaneously, the stop loss levels would move upward or downward in proportion to the actual price movement. This feature, which is often called, “tightening the stops,” and is currently available, but has not been available in conjunction with the scientifically generated suggested take profit or stop loss from the above-discussed neural engine.

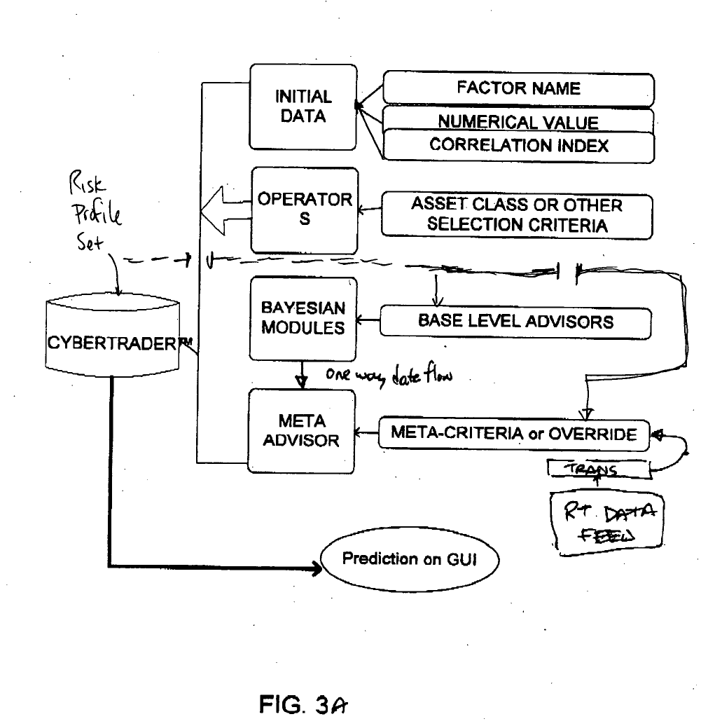

The adjustable risk profile system is detailed in FIGS. 3A and 3B. In FIG. 3A, the selection of the risk profile analysis is depicted in which a user can choose between pre-defined risk profiles and manually set ones. Of course, as can be appreciated by the those skilled in the art, different risk profiles can be set to account for different parameters or circumstances, which may be automatically provided or monitored by certain embodiments of the invention.

The real-time input required for the “stock market specific” version of the product incorporates many asset classes, as the futures and even options that are at the root of the markets make the best indicators of change for the project. The invention also includes a novel presentation or view of the product as a redirection engine that incorporates real time input and is capable, with different sets of input information, of price and direction, buy, sell, hold, and confidence in a great many asset classes including but

The ultimate goal being possibly a real time forecast feed. The ability to increase the frequency of predictions is directly related to the inclusion of the “decision factors” of choosing. Prior to the inclusion of these “real time” factors, the (prior art version) of the system was more reactive than pro-active. The goal immediately became to make the brokerage firms' clients more profitable (or less unprofitable) and to stimulate trading activity. That was the reason so many changes and additions were required to both the inputs, outputs and timing thereof. Instead of simply producing Buy, Sell, Hold recommendations, the invention uses actual dollar prices. The invention then moved to forecasting a specific price movement for each stock, complete with direction of movement, magnitude of movement (both in % and in dollars), and confidence of movement.

Stoploss/profit recommendations a lot outclassed America to be provided with meaningful recommendations as there may be functionally dynamically generated information it. Specifically to each of the current market environments. Stoploss and take profit levels are not a fixed distance from the recommended price and tree but dynamically adjusted with each new prediction, sometimes with a particular relationship (positive correlation) to the current price, sometimes another (such as a negative correlation).

The customer is passively presented with a scientifically calculated stoploss and take profit waits a canned choice to accept are not savvy trader users can. The present invention allows customers to automatically load the alert function based upon me stoploss and/or take profit recommendations. These recommendations can be teamed or adjusted to meet specific savvy trader objectives as well as other platforms for example the take profit recommendations been a more conservative, to help ensure that read to customers cash or profit more frequently pay additional fees.

Additional customers will be able to see at a glance predicted that is that are most important e.g. it does it affect the securities that they are contracted for considering there that are no indicators or operators to understand. In general, factors are selected for inclusion in particular applications and generally consist of financial instruments that the is there as determined have a relationship directly and indirectly to the price action of the instruments the way is you wish is to trade our hat these relationships may be measured as either negative or positive correlations which may make up the optional third part of the awry. The objective is teasing on if system to process time series data far any of said that man's self-serve as a leading or lagging indicator. Any valid relationships and appendices include those that are not here will be detected in use by the system to learning mechanisms contributing to the accuracy of each prediction task.

In order to generate as many trading opportunities for the clients of particular platforms, the present invention incorporates increasing the frequency forecasts. Increase the frequency of the forecasts, ultimately to approach real-time forecasts and limited only by band width and processing power. The present invention recommends an actual dollar price in a preferred embodiment, but may be tailored to suit other end-use needs.

The present invention also calculates and displays confidence levels relating to the confidence in the direction of price movement, but also anticipates not the magnitude. The next embodiment of the invention agreed to start implementing with magnitude confidence levels.

In a first embodiment the prior-art neural analysis engine includes the following data or information structures. Factor: Array (Numerical Data, Correlation): The first component of factors may be a stock price or collection of data. The indicators discussed above in the background regarding the neural analysis engine may also be mathematical or complex operators in a particular embodiment: Mathematical or logical functions that transforms a factor into recognizable data. Base-Advisors are generally single or compound Baeysan Logic Modules that determine inclusion or exclusion of transformed data for a number of circumstances. The meta-Advisor is Set/Fuzzy Logic with adjustable parameters that analyzes multiple base advisors.

In a first embodiment, the invention uses a computer-implemented method for assisting in an equity trade in which a processor is executing instructions that perform the following acts: selecting from a group of mathematical operators to transform a set of arrays located in data storage; performing said mathematical operations of a set of arrays, such that preliminary data is produced; analyzing said preliminary data with a first set of Baeysian-logic functions, each with a corresponding adjustable weights; and determining a recommendation for the equity based on the above-described Baesyian logic analysis, and reporting the recommendation to a user as output; and comparing an actual result for the equity to the recommendation and adjusting at least one of the Bayesian logic functions or modules corresponding weights for any future recommendation (punishment/reward), and the invention includes setting an adjustable risk profile for an equity trade and using a real-time feed to the neural analysis engine which may require interpretation to effectively update the array of factors or other pre-cursor data sets.

The real-time or near real-time feed is shown in FIG. 4 as it may be distributed to each of the components of the neural analysis engine, although, in general it will need increasing levels of conversion as it moves higher up into the neural network. Also, in general, the real-time data does not need to be fed into the operators/indicators as these are functions that will perform mathematical functions on the factor data anyway. However, given enough computational power, there may be an application in which the operator and factor are alike with regard to certain properties.

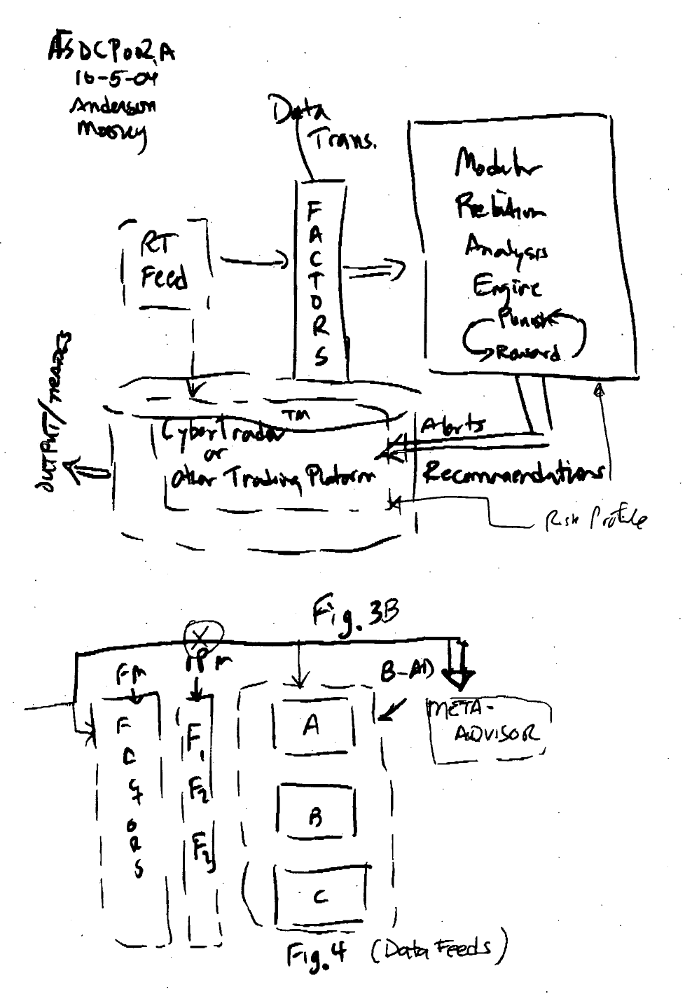

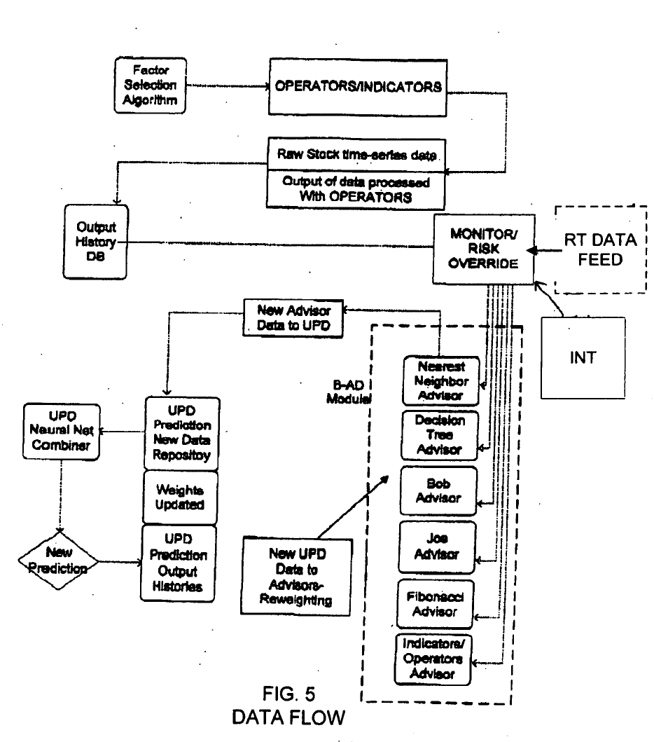

In addition to the four components, some of which are included in the prior art neural-analysis engine discussed in the background section there is a Risk Management Override Boolean which is shown in FIG. 5. The override is a monitor that continually assess market conditions and will generate a stop loss/take profit instruction when needed and is discussed at length below for it versatile implementation.

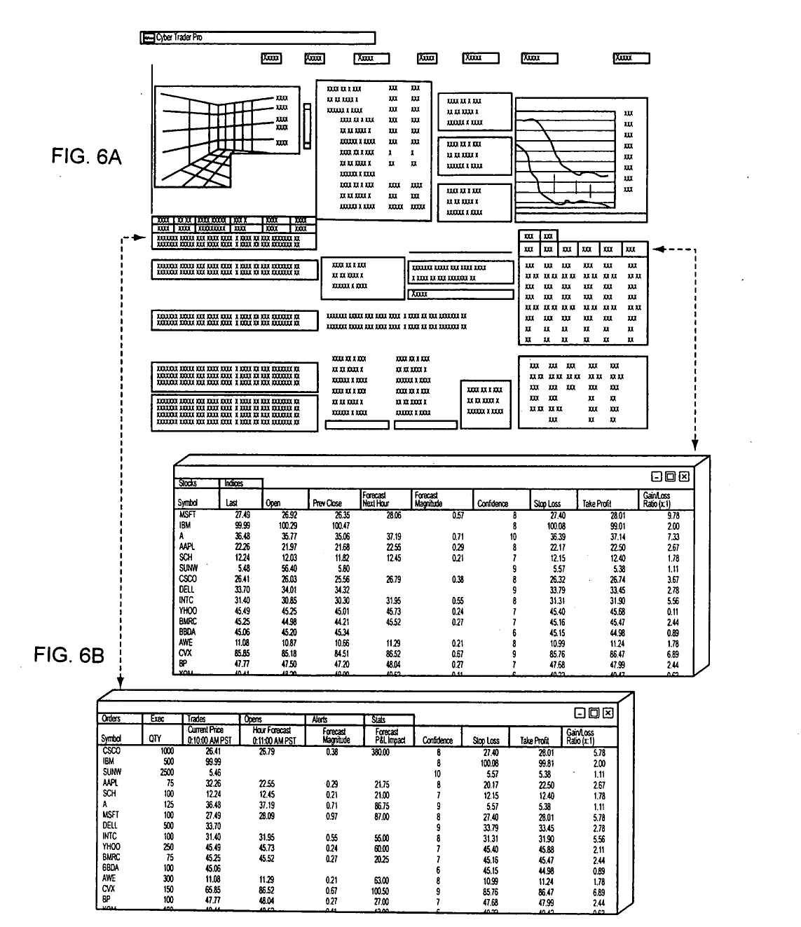

Referring now to FIGS. 6A-6B, a sample output series of display screens is shown, although the invention is not limited to any particular type of output, these screenshots illustrate some of the relevant features. For example, in many embodiments the confidence statistic or results in this an important part of the commercial desirability. Confidence can be measured along several different lines as having described below.

The present invention in a preferred embodiment, includes several types of confidence level output which is shown in FIG. 6B. For example, Confidence level-A is a Normalized Scale from 1-10 that indicates the predicted of a movement of a commodity and/or equity. Another type of confidence level-M, which is confidence in the change of the magnitude, is also normalized on a Scale 1-10.

FIG. 7 shows an embodiment of the invention in which the real-time data feed is used or “intersticed” into the neural analysis engine, such that it can adjust the trading recommendation based on a number of factors and virtual configurations. As can be appreciated by those skilled in the art, the real-time feed and override/adjustment system can operate either internally or externally to the neural analysis engine discussed in the background to the application. While some situations would indicate that computing power would economized by building in these features, other computing environments would benefit from externally controlled, either from another computer or monitoring program.

In FIG. 7, a monitor layer ML, has the ability to bypass either separately or in conjunction with the Bayesian layer B-AD to inform the trader that the user set risk level or other parameter (factor, relation, etc, as will be discussed below) or condition has been met based on the real-time data feed or other data. Thus, the ML bypasses the meta-advisors to let the trader know that said condition exists, or rather that a trade should be made based on the risk profile.

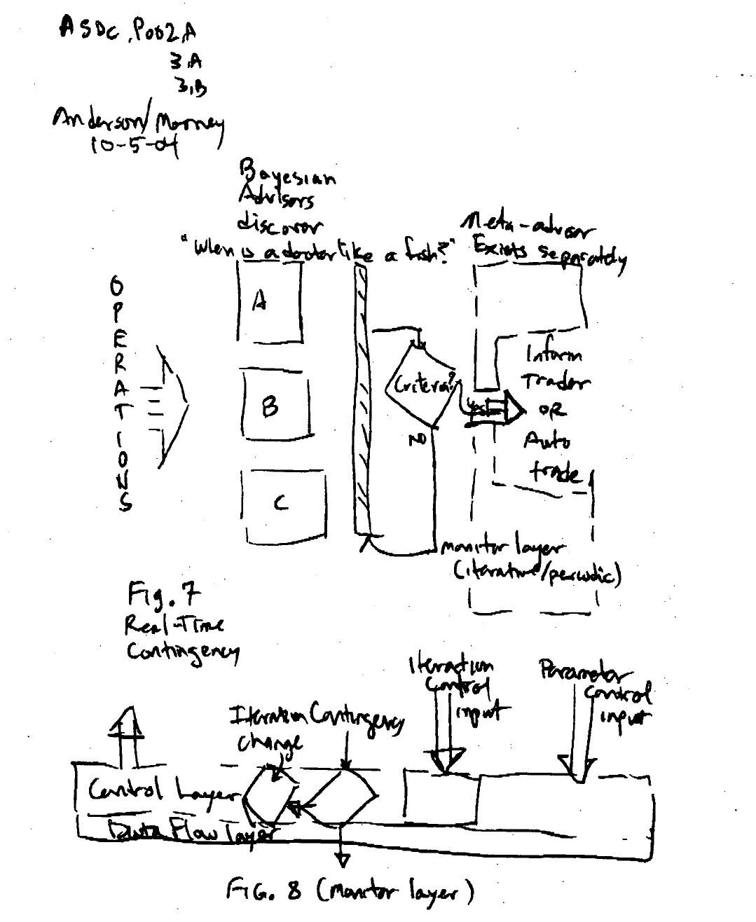

FIG. 8 shows the representative functions of the external or internal monitor layer ML. The parameter control input may accept real-time data directly from a feed that is also supplied to CYBERTRADER™ or other trading program. The parameter control input may accept several layers of direct or “interpreted” data, such as factor/arrays or from the Bayesian advisors or a combination of such advisors. The interaction control input acts a “data traffic cop” between all the layers or data the layer must manage. Thus, this layer is particularly effective when running on the same computer or processor as the neural analysis engine, but is architecturally separated from the engine. Thus, the monitor layer ML can have the level of complexity desired by the end-user without necessarily interfering with the neural analysis engine.

The contingency module shown in the monitor layer, is simply the criteria to either continue as normal or inter alia, notify the trader that a condition or risk profile condition has been met or that another factor leading to the immediate recommendation that a trade be executed (or optionally providing instructions to execute the trade automatically). If conditions do not merit the immediate contingency bypass, the situation is analyzed for “iteration” adjustment. Iteration adjustment is one of the computation control mechanisms that may respond to real-time data either directly on through interpretation. Other internal operations of the neural analysis engine may also be adjusted, although too much control from external data may interfere with the machine learning process and the scalable nature of iteration makes is less likely that the neural processes will be disturbed simply by asking them to perform their relationship determinations (“why is a doctor like a fish?”) more frequently. The control of the processes may be adjusted through instructions provided by the monitor layer ML.

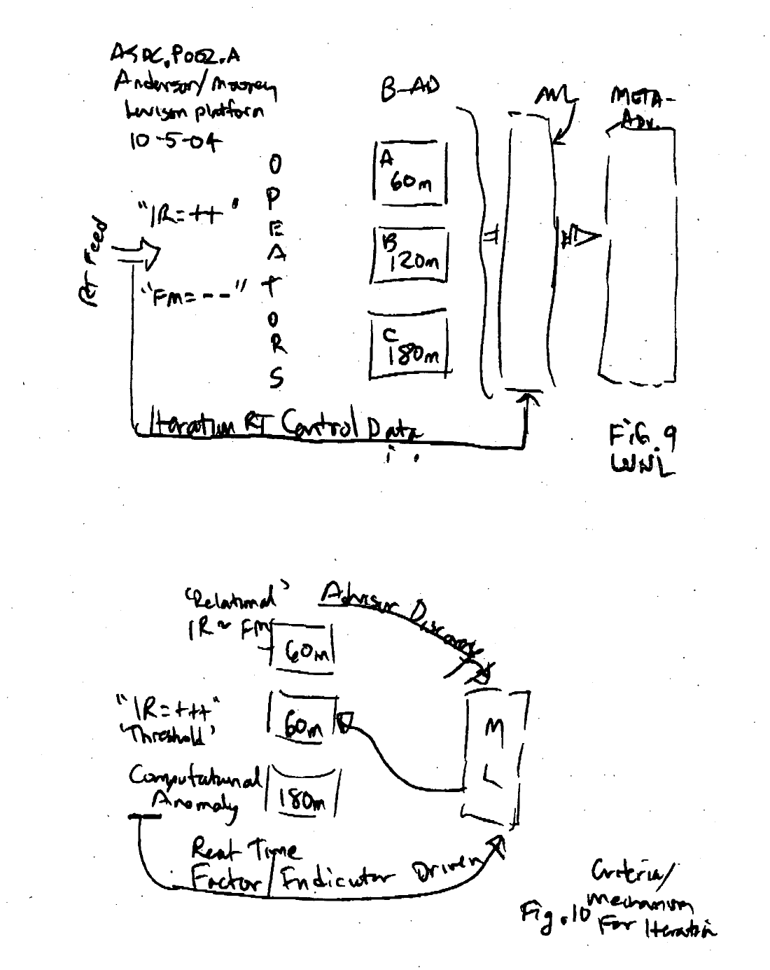

Referring now to FIG. 9, a real-time data feed is fed into the monitor layer ML directly from the factors or data arrays for iteration control purposes.

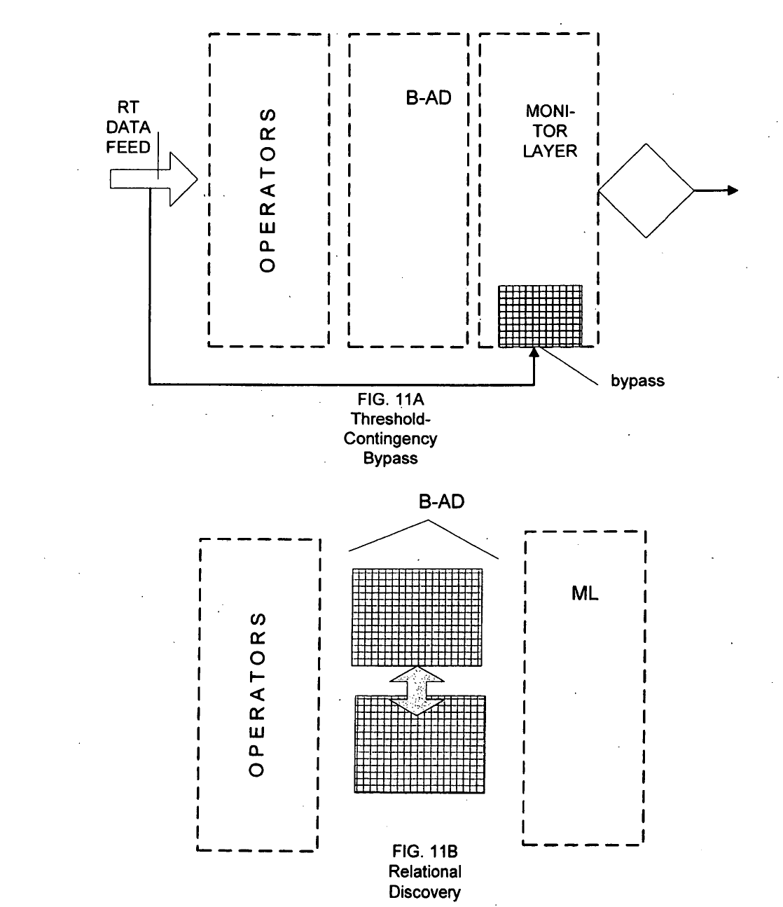

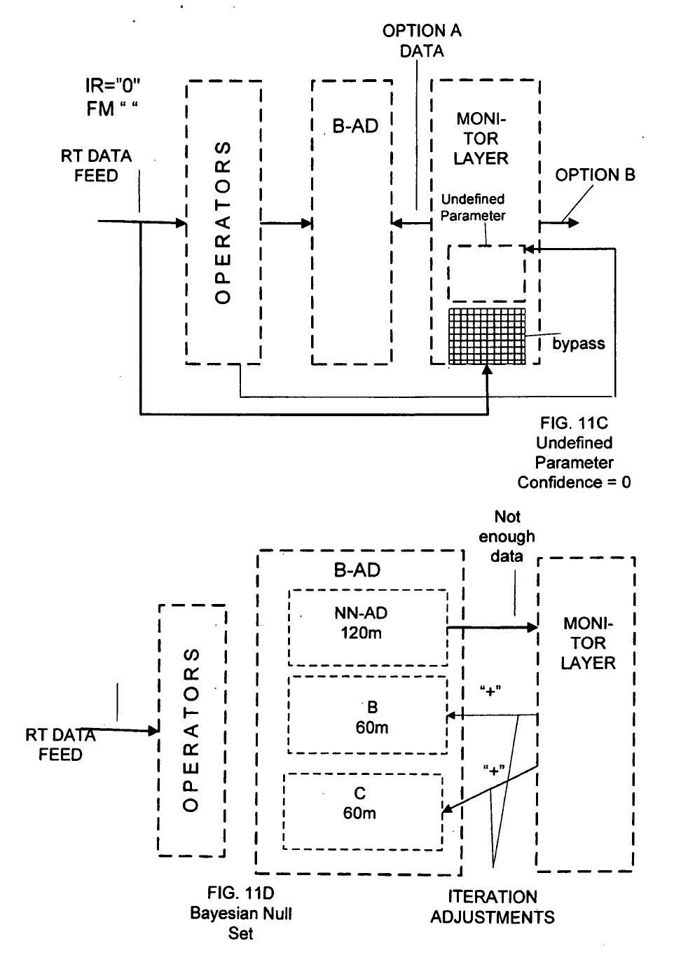

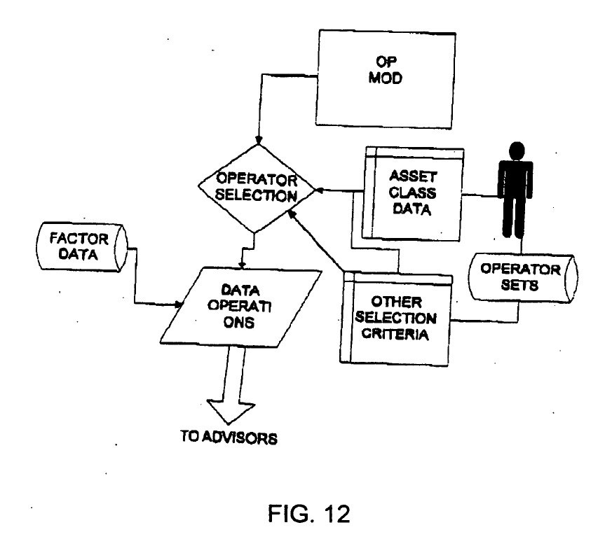

FIG. 10 shows an iteration adjustment from the system as shown in FIG. 9 for the Baeysian logic module B-AD. The B advisor changes it monitoring from 120 mins to 60 mins based on a real-time factor condition (shown as “IR=+++” which may stand for interest rates have risen at an unexpected rate) shown by the bottom data flow arrow. The interaction change may also have resulted from a “discovery” by the logic module B-AD of a new relationship or cautionary situation (shown as IR˜FM, or an approximate direct and proportional correlation) which is indicated by the top data flow arrow. Other items that could result in iteration control of one or more individual modules in the Baeysian logic module B-AD are discussed below in FIGS. 11A-D, but are not limited to such conditions.

Unlimited computational power would affect the need to continually perform the neural analysis and may eventually allow certain advisors to run continually. However, there is also a risk that the discovery of certain relationships may actually be destroyed by setting the interval to small.

FIGS. 11A-11D proposed some possible relationships or determinations that would lead to an override situation, but are also applicable to the iteration control discussed in FIGS. 9 and 10 above. FIG. 11A simply shows that a factor in the data array provides a piece of data in the monitor layer that leads to a contingency implementation for trade notification or other scenario. Needless to say, the by-pass based on a singular factor is not meant to replace the operation of the neural analysis engine, but is meant to set forth only in the most serious of conditions or based on a particular factor in the risk profile. FIG. 11B shows a that a contingency by-pass may also be developed from a “discovered relationship” between a couple of neural modules in the Baeysian logic module B-AD.

FIG. 11C shows that a “no confidence” or undefined parameter may also trigger a by-pass situations. This particular aspect is more complex because there are an infinite amount of undefined relations that can be created though machine learning. However, it may useful to consider key undefined parameters from the operations as an operator that flags a particularly unusual anomaly is communicating that the normal mathematical operations are not useful in the present situation related to the data feed. Optionally, as shown in FIG. 11D a particular Baeysian null set or lack of information (“misfire”) may provide the by-pass or optionally, iterative adjustment discussed above. FIG. 13 shows that the iterative adjustment (or the by-pass) may be provided by a signal from an external computer.

The quality of the present invention is partially dependent on the quality of the input. Choosing from a large number of more specifically targeted inputs to populate the parameters which include the factors and the set of operators that will be used. The major obstacle was that there literally tens of thousands of possible candidates for inclusion in the model. The present inventions obtain a complete global data set for research. In particular embodiments, the initial data set is chosen from those data items the ones best suited for the general stock forecasting needs, as opposed to being limited to mutual funds or other items. The inputs most closely correlated to the expected price movement of the basket stocks. These inputs consisted of other stocks in the same industry as some of our target stocks, market indices, sector indices (such as SOX) certain commodity prices and fixed income futures prices.

For example, as may be appreciated by those skilled in the art, interest rates, and interest expectations, drive all financial markets. Therefore there must be a connection to interest rates included among the factors. They also “lead” the markets temporally, thus acting as an “early warning” or leading indicator of market moves that are about to occur. Certain interest rate securities or derivatives reflect the current demand for borrowing and the relationship of that demand to the currently available supply of money for lending. Other interest rate securities and derivatives are more useful in determining the market participants' expectations of interest rate movement, and the possible magnitude of that movement, in the future.

The present invention has the ability to allow a trader to “auto-populate” the trade execution screen based on forecasts. As can be appreciated by those skilled in the art, the invention is not limited to foreign exchange, fixed income, futures and options.

In another embodiment, for high-wealth but less-active clients, the invention allows transmission for end-of-day forecasts along with the account summary sent out to Schwab's clients nightly. This would allow the investors to review their holdings nightly (as about 85% of individual investors do, according to several studies), make decisions about their actions for the next day, based in part on our forecasts for their specific holdings, and input trade orders that night, to be executed at the open of the market the next day. They would also have the ability to require a specific price for their orders, if they preferred a limit order to a market order.

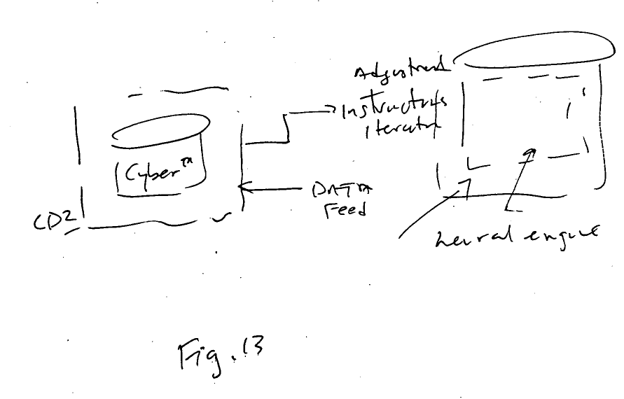

Referring now to FIG. 12, a sample system for adjusting the operators or indicators is shown. The operators are generally mathematical and/or logical functions that transform the array data or factor data. Stored pre-defined or ad hoc selection of operators may be dependent of the class of the asset, but may also be chosen based on other factors, such as market conditions, etc. The present invention takes advantage of numerous techniques and features which would lead to significantly increased trading volume in order to benefit the brokerage firms by giving them a competitive advantage within the active trader community. For example, writing it specifically for the stock market would omit such markets as Foreign Exchange, Fixed Income, Futures, Options and other asset classes, all of which lend themselves to the powerful analytical capabilities of the base invention. The invention would provide many advantages to target markets by implementing the real-time capability as non-asset specific. Every asset class has its own set of technical indicators and inputs similar to the stock market

In another embodiment, the invention is a computer-implemented risk-profile adjustment system run on neural-based trading recommendation means, which is the neural analysis engine discussed in the background section above, where the improvement allows a trader to determine at least one of their own risk levels, in which each said of said levels is configured to have an automatically triggered stop-loss or take-profit associated with it, providing the trading recommendation engine with a real-time data feed, where the trading recommendation engine generates suggested take profit and/or stop loss recommendations.

Optional features include where the content of the output that further includes using actual dollar prices, the output includes forecasting a specific price movement for each stock, the output includes with direction of movement, magnitude of movement, and confidence of movement.

Other optional features includes where the equity trade is not recommended unless said confidence level is above a user-specified target, the equity trade cannot be placed unless said confidence level is above a target level, or the confidence data is normalized, such that it is scaled from 1 to 10 as output. Other optional features include a third-party trading system capable of performing rolling-stop losses.

In another embodiment, the invention uses a computer-implemented method for assisting in an equity trade in which a processor is executing instructions that perform the following acts: selecting from a group of mathematical operators to transform a set of arrays located in data storage; performing said mathematical operations of a set of arrays, such that preliminary data is produced; analyzing said preliminary data with a first set of Baeysian-logic functions, each with a corresponding adjustable weights; and determining a recommendation for said equity based on said Baesyian logic analysis, and reporting said recommendation to a user as output; and comparing an actual result for said equity to said recommendation and adjusting at least one of said Bayesian logic function corresponding weights for any future recommendation, wherein the invention includes using interest rate data for said stored data arrays.

In a third embodiment the invention uses a computer-implemented method for assisting in an equity trade in which a processor is executing instructions that perform the following acts: selecting from a group of mathematical operators to transform a set of arrays located in data storage; performing said mathematical operations of a set of arrays, such that preliminary data is produced; analyzing said preliminary data with a first set of Bayesian-logic functions, each with a corresponding adjustable weights; and determining a recommendation for said equity based on said Bayesian logic analysis, and reporting said recommendation to a user as output; and comparing an actual result for said equity to said recommendation and adjusting at least one of said Bayesian logic function corresponding weights for any future recommendation, wherein the invention includes setting an adjustable risk profile for at least one equity trader and publishing stop loss and take profit levels generated by executable instructions.

Other variations of the invention include where the output ranks multiple equities by confidence level, both on the buy side and on the sell side. The output includes with direction of movement, magnitude of movement, and confidence of movement. The equity trade is not recommended unless said confidence level is above a user-specified target; the equity trade cannot be placed unless said confidence level is above a target level, the confidence data is normalized, such that it appears scaled from 1 to 10 on said output.

The set of arrays include data relating to interest rates, and the set of arrays include data relating to foreign equity markets.

Other embodiments, include a computer-implemented method for assisting in an equity trade in which a processor is executing instructions that perform the following acts: selecting from a group of mathematical operators to transform a set of arrays located in data storage; performing said mathematical operations of a set of arrays, such that preliminary data is produced; analyzing said preliminary data with a first set of Baeysian-logic functions, each with a corresponding adjustable weights; and determining a recommendation for said equity based on said Baesyian logic analysis, and reporting said recommendation to a user as output; and comparing an actual result for said equity to said recommendation and adjusting at least one of said Bayesian logic function corresponding weights for any future recommendation, wherein the improvement includes setting an adjustable risk profile prior to said equity trade and providing a real-time data feed to said processor.

the recommendation is reported to a third-party trading system, in which the third-party trading system is capable of performing rolling-stop losses.

the content of the output uses actual dollar prices.

the output includes forecasting a specific price movement for each stock.

the output includes with direction of movement, magnitude of movement, and confidence of movement.

Other optional features of the invention include implementations in which the equity trade is not recommended unless said confidence level is above a user-specified or scientifically generated target. The confidence data may be normalized, such that it is scaled from 1 to 10 or other easily/quickly recognizable analyzed system. Even more optional features include real-time data feed is modified prior being presented to said processor or where the modification involves a data translation step.

In yet another embodiment, the invention is a computer-implemented method for assisting in a commodity transaction in which a processor is executing instructions that perform the following acts: selecting from a group of mathematical operators to transform a set of arrays located in data storage; performing said mathematical operations of a set of arrays, such that preliminary data is produced; analyzing said preliminary data with a first set of Baeysian-logic functions, each with a corresponding adjustable weights; and determining a recommendation for said equity based on said Baesyian logic analysis, and reporting said recommendation to a user as output; and comparing an actual result for said equity to said recommendation and adjusting at least one of said Bayesian logic function corresponding weights for any future recommendation, wherein the improvement includes the acts of: setting a target interval for said analysis step; providing a real-time data feed to said processor, said real-time data feed providing information for at least one of said set of arrays; and performing said analysis step at each target interval. Optional features of this embodiment target interval is set manually wherein said target interval is set automatically based on a trader-chosen factor, wherein the target interval is adjusted by shortening the interval the target interval is adjusted by shortening or lengthening said interval based on computational constraints. The real-time feed can also be fed to a commodity trading computer. The target interval can be shortened based on information flagged from said real-time data feed to said commodity trading computer, said commodity trading computer instructing said processor to shorten said target interval.

In yet another embodiment, the invention is a computer-implemented method for assisting in an equity trade in which a processor is executing instructions that perform the following acts: selecting from a group of mathematical operators to transform a set of arrays located in data storage; performing said mathematical operations of a set of arrays, such that preliminary data is produced; analyzing said preliminary data with a first set of baeysian-logic functions, each with a corresponding adjustable weights; and determining a recommendation for said equity based on said Baesyian logic analysis, and reporting said recommendation to a user as output; and comparing an actual result for said equity to said recommendation and adjusting at least one of said Bayesian logic function corresponding weights for any future recommendation.

The above-following illustrations and descriptions are meant to assist the skilled artisan in understanding the various embodiments and implementations that are possible in the present invention. These illustrations should not be considered limitations, but as particular embodiments of following claims.

1. A computer-implemented method for assisting in a commodity transaction in which a processor is executing instructions that perform the following acts: selecting from a group of mathematical operators to transform a set of arrays located in data storage; performing said mathematical operations of a set of arrays, such that preliminary data is produced; analyzing said preliminary data with a first set of Baeysian-logic functions, each with a corresponding adjustable weights; and determining a recommendation for said equity based on said Baesyian logic analysis, and reporting said recommendation to a user as output; and comparing an actual result for said equity to said recommendation and adjusting at least one of said Bayesian logic function corresponding weights for any future recommendation, wherein said improvement includes the acts of:
setting a target interval for said analysis step;
providing a real-time data feed to said processor, said real-time data feed providing information for at least one of said set of arrays; and
performing said analysis step at each target interval.

2. The method as recited in claim 1, wherein said target interval is set manually.

3. The method as recited in claim 1, wherein said target interval is set automatically based on a trader-chosen factor.

4. The method as recited in claim 1, wherein said target interval is adjusted by shortening the interval.

5. The method as recited in claim 1, wherein said target interval is adjusted by shortening or lengthening said interval based on computational constraints.

6. The method as recited in claim 5, wherein said computational constraints are monitored.

7. The method as recited in claim 5, wherein said real-time feed is also fed to a commodity trading computer.

8. The method as recited in claim 7, wherein said target interval is shortened based on information flagged from said real-time data feed to said commodity trading computer, said commodity trading computer instructing said processor to shorten said target interval.

9. The method as recited in claim 1 assisting in an equity trade in which a processor further including wherein the improvement includes setting an adjustable risk profile for said equity trade.

10. A computer-implemented method for assisting in an equity trade in which a processor is executing instructions that perform the following acts: selecting from a group of mathematical operators to transform a set of arrays located in data storage; performing said mathematical operations of a set of arrays, such that preliminary data is produced; analyzing said preliminary data with a first set of baeysian-logic functions, each with a corresponding adjustable weights; and determining a recommendation for said equity based on said Baesyian logic analysis, and reporting said recommendation to a user as output; and comparing an actual result for said equity to said recommendation and adjusting at least one of said Bayesian logic function corresponding weights for any future recommendation, wherein the improvement includes setting an adjustable risk profile for at least one equity trader and publishing stop loss and take profit levels generated by executable instructions, prior to performing any of said mathematical operations wherein:
a step is performed prior to said determining step to analyze real-time data in order to determine whether a set of one or more contingency conditions have been met.

11. The method as recited in claim 10 wherein said contingency conditions include data that shows whether a triggered stop-loss or take-profit has been met.

12. The method as recited in claim 11, wherein suggested take profit and/or stop loss recommendations are provided immediately if said contingency condition have been met.

13. The method as recited in claim 10, in which at least one of said set of contingency conditions is configured to be triggered with the price movement of at least particular stock.

14. The method as recited in claim 10, in which at least one of said set of contingency conditions is configured to be triggered with the movement of at least one of said set of indicators.

15. The method as recited in claim 10, in which at least one of said set of contingency conditions is configured to be triggered by a discovered correlation.

16. The method as recited in claim 15, wherein said discovered correlation is between two or more of said set of indicators.

17. The method as recited in claim 15, wherein said discovered correlation is between one of said advisors and a second piece of data.
